(19) United States
(12) Patent Application Publication
(10) Pub. No.: US 2018/0012515 A1
(43) Pub. Date: Jan. 11, 2018

(54) MEDICAL SIMULATION APPARATUS

(71) Applicant: The General Hospital Corporation, Boston, MA (US)

(72) Inventors: Gregory J. Loan, Arlington, MA (US); Tiffiny Hron, Boston, MA (US); James Burns, Dover, MA (US); James Kobler, West Roxbury, MA (US)

(21) Appl. No.: 15/544,201

(22) PCT Filed: Jan. 20, 2016
(86) PCT No.: PCT/US16/14077

§ 371 Date: Jul. 17, 2017

Related U.S. Application Data
(60) Provisional application No. 62/106,684, filed on Jan. 22, 2015.

(51) Int. Cl. G09B 23/28; G09B 9/00; G09B 23/32; G09B 23/34

(52) U.S. Cl. CPC G09B 23/285; G09B 23/34; G09B 9/00; G09B 23/32

(57) ABSTRACT

Systems and methods for simulating medical procedures are provided. In one example, systems and methods are provided for a neck simulator that presents realistic interactions with the neck during medical procedures, including injections, such as may be performed during a laryngeal injection.

### CROSS-REFERENCES TO RELATED APPLICATIONS

The present application is based on, claims priority to, and incorporates herein by reference in its entirety, U.S. Provisional Patent Application No. 62/106,684, filed Jan. 22, 2015 and entitled “Medical Simulation Apparatus.”

### STATEMENT REGARDING FEDERALLY SPONSORED RESEARCH

Not Applicable.

### BACKGROUND

The disclosure relates generally to medical procedures and, more specifically, to medical simulation devices used to assist in the training of physicians and medical clinicians in performing medical procedures involving injections.

Medical simulation devices are used to assist in the training of physicians in performing a variety of medical procedures. For example, some medical procedures that use simulation devices for training include intubation, intravenous insertion, CPR, and defibrillation, to name a few. The medical simulation devices provide physicians, and students, a hands-on training experience before having to perform the medical procedures on patients. Furthermore, the medical simulation devices enable the training of certain medical procedures that are impractical to practice multiple times on a living patient, such as intubation. The training enabled by the medical simulation devices can aid in the prevention of medical errors and reduce the need for a medical training facility to purchase expensive cadavers.

### BRIEF SUMMARY

The present disclosure provides systems and methods for simulating medical procedures, particularly, those performed on the neck of a patient. In particular, systems and methods are provided for a neck simulator that presents realistic interactions with the neck during medical procedures, including injections, such as may be performed during a laryngeal injection.

The present disclosure provides a medical simulation apparatus including a first tissue block fabricated from one or more layers each providing substantially different material properties, a second tissue block fabricated from a material with a hardness between about OO-10 and OO-20, one or more muscle elements fabricated from a muscle material with a hardness between about 5 A and 30 A, and one or more framework elements fabricated from a framework material with a hardness between about 15 D and 130 R.

In another aspect, the present disclosure provides a medical simulation apparatus including a first tissue block having a first aperture extending between a first opening in the first tissue block to a second opening in the first tissue block to form a lumen extending through the first tissue block. The medical simulation apparatus further includes a second tissue block arranged within the first aperture of the first tissue block and includes one or more indentations and a second central aperture extending along the lumen from the first opening to a position between the first opening and the second opening. The medical simulation apparatus further includes a needle having an electrical conductor providing communication between the needle and an input, and a processor in communication with a speaker and the input. The processor is configured to instruct the speaker to play an audible sound upon the needle being inserted through the first tissue block to contact at least one of the one or more indentations in the second tissue block.

In yet another aspect, the present disclosure provides a medical simulation apparatus configured to simulate a human neck. The medical simulation apparatus includes a first tissue block having a first surface, a right aperture, a left aperture, and a central aperture. The first surface defines an elongated external surface dimensioned to approximate a human neck. The medical simulation apparatus further includes a right muscle element arranged within the right aperture that provides a right palpable feature on the first surface, a left muscle element arranged within the left aperture that provides a left palpable feature on the first surface, and a laryngeal framework arranged within the central aperture that provides a central palpable feature on the first surface.

In still another aspect, the present disclosure provides a method for simulating a medical procedure on a neck of a human patient using a medical simulation apparatus. The medical simulation apparatus includes a first tissue block having a first aperture extending between a first opening in the first tissue block to a second opening in the first tissue block, a second tissue block arranged within the first aperture of the first tissue block and having one or more indentations, and a processor in communication with a speaker and an input. The method includes electrically coupling a needle to the input of the medical simulation apparatus, inserting the needle through the first tissue block towards the second tissue block, determining if the needle contacts at least one of the one or more indentations in the second tissue block, and instructing, via the processor, the speaker to play an audible sound, if the needle contacts at least one of the one or more indentations in the second tissue block.

The foregoing and other aspects and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims and herein for interpreting the scope of the invention.

### BRIEF DESCRIPTION OF DRAWINGS

The invention will be better understood and features, aspects and advantages other than those set forth above will become apparent when consideration is given to the following detailed description thereof. Such detailed description makes reference to the following drawings.

FIG. 1 shows an exploded view of a medical simulation apparatus in accordance with one embodiment of the present disclosure.

FIG. 2 shows a cross-sectional view of the medical simulation apparatus of FIG. 1.

FIG. 3 shows a cross-sectional view of a portion of the medical simulation apparatus of FIG. 1.

FIG. 4 shows perspective view of a neck assembly of the medical simulation apparatus of FIG. 1 with a first tissue block of the neck assembly shown as transparent.

FIG. 5 illustrates the steps for using the medical simulation apparatus of FIG. 1 to simulate an injection into the laryngeal musculature according to one embodiment of the present disclosure.

### DETAILED DESCRIPTION

Currently, acquisition of manual skills and a 3D anatomical understanding necessary to perform injections into laryngeal musculature are difficult to acquire for a physician, or a medical student, during otolaryngology training. Furthermore, use of a cadaver is impractical because the cadaver is expensive to procure and is subject to degradation over time. Additionally, the cadaver no longer contains living tissue and, therefore, is unable to simulate electromyographic sound used to assist the physician, or the medical student, in correctly locating the muscle targets in the larynx during injections into the laryngeal musculature.

Due to the current difficulties in obtaining the skills necessary to perform injections into the laryngeal musculature, it would be desirable to have a medical simulation apparatus that includes life-like material properties, palpable anatomically correct features, and incorporates auditory feedback to indicate accurate positioning of a needle during the injection. This would enable a physician, or a medical student, to obtain the training and experience necessary to successfully perform injections into the laryngeal musculature. Furthermore, such a medical simulation apparatus could be used for other training procedures apart from laryngeal injections. Further still, the components and design of such a medical simulation apparatus can be used to create other medical simulation systems that present anatomy other than the neck. For example, realistic simulation of skin, soft tissue, muscle, and cartilage can be used to present proper anatomical simulation of a variety of portions of the body.

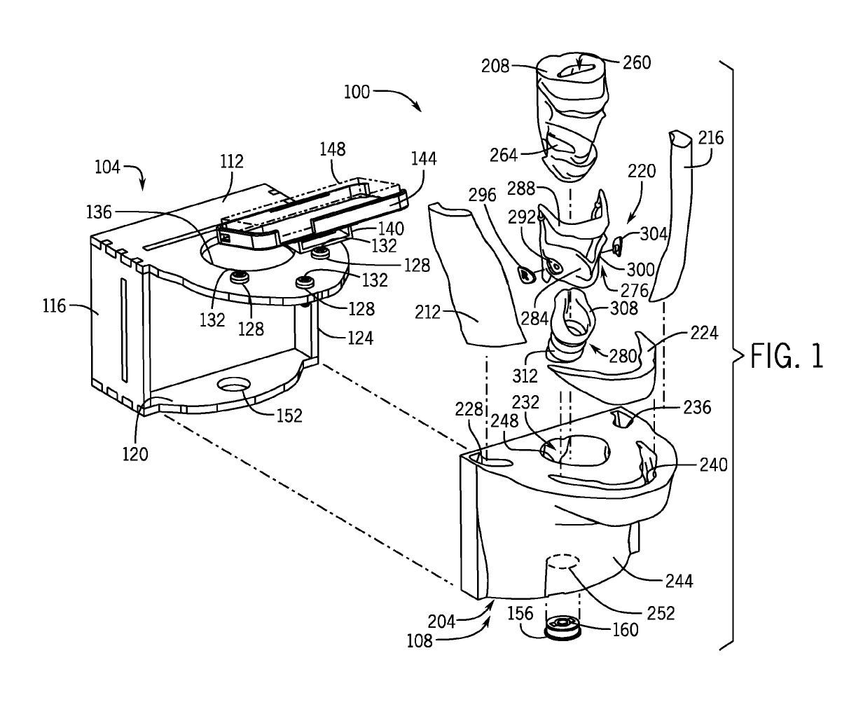

FIG. 1 shows an exploded view of one non-limiting example of a medical simulation apparatus 100. The medical simulation apparatus 100 includes a base 104 and a neck assembly 108 configured to be mounted in the base 104. The base 104 includes a first side 112, a second side 116, a third side 120, and a fourth side 124. The base 104 may be fabricated from a plastic material, for example, polyvinylchloride or polyethylene. In other configurations, the base 104 can be fabricated from a rubber material, a metal, a composite material, or another material known in the art.

The first side 112 of the base 104 includes a plurality of mounting apertures 128 each configured to receive a fastening element 132 in the form of a bolt or a screw and a viewing aperture 136 arranged to provide a view into the neck assembly 108. In the illustrated configuration, the first side 112 of the base 104 includes three mounting apertures 128. In other configurations, the first side 112 of the base 104 may include more or less mounting apertures 128, as desired. A bracket 140 is attached to the first side 112 of the base 104, which is coupled to a display mounting 144. The display mounting 144 is configured to arrange a display 148 including a camera to view into the neck assembly 108 and acquire images and/or video. The display 148 can be a mobile computing device in the form of a cell phone or a tablet, or the display 148 may be a dedicated screen controlled by additional electronic components, as will be described.

The third side 120 of the base 104 includes a button aperture 152 configured to receive a push button 156. The push button 156 includes an electrical connector 160 attached to the push button 156 and configured to receive one or more electrical contacts. In other configurations, the electrical connector 160 may be attached to the base 104 or located remote from the base 104, as desired. When installed into the button aperture 152, the push button 156 is configured to displace in a longitudinal direction when a user presses on the push button 156. The push button 156 may include an electronic actuator that enables the displacement of the push button 156 to be controlled electronically.

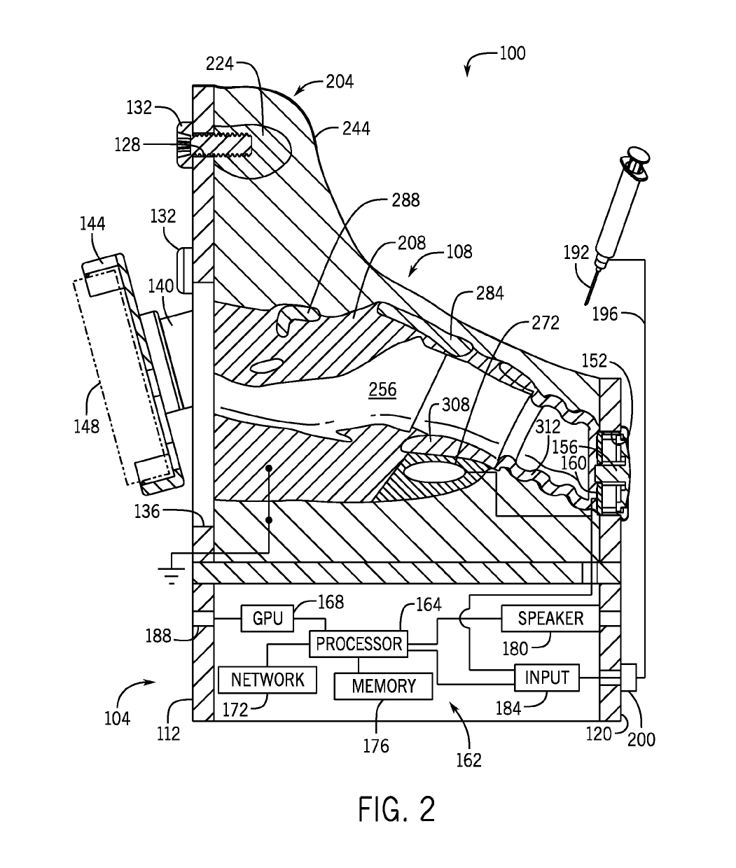

FIG. 2 shows a cross-sectional view of the medical simulation apparatus 100 illustrating an electrical control system 162 mounted within the base 104. The electrical control system 162 includes a processor 164 in communication with a variety of components that may be optionally included, such as a graphics processing unit (GPU) 168, a network 172, a memory storage device 176, a speaker 180, and an input 184. In other configurations, the electrical control system 162 may be mounted remotely from the base 104.

If included, the GPU 168 may be in communication with a GPU input port 188 that can be an RS232 port, a HDMI port, a VGA port, or any video input port known in the art. In one configuration, the display 148 may be a screen that is connected to the GPU 168 through the GPU input port 188. The GPU 168 can be configured to drive the display 148 to display images and/or video. In another configuration, the display 148 may be a mobile computing device in the form of a cell phone or a tablet with an integrated graphics card and not connected to the GPU 168 and the GPU may be omitted in this or other configurations.

The network 172 can be configured to provide wireless communication between the display 148 and the processor 164. The network 172 may be configured to wirelessly communicate using WiFi, Bluetooth®, or any of a variety of methods of wireless communication known in the art or developed in the future. The network 172 can be further configured to communicate with a server and/or a cloud type storage system to store the images and/or video acquired using the camera on the display 148 and saved on the memory storage device 176. In another configuration, the network 172 may be connected to an Ethernet port and provide a wired connection between the memory storage device 176 and the server and/or the cloud storage system.

The input 184 is in communication with the electrical connector 160 and a needle 192. The needle 192 includes an electrical conductor 196 connected to an input port 200 providing communication between the needle 192 and the input 184.

With reference to FIGS. 1-3, the neck assembly 108 may include a variety of components with different properties. In the illustrated, non-limiting example, the neck assembly 108 includes a first tissue block 204, a second tissue block 208, a right muscle element 212, a left muscle element 216, a laryngeal framework 220, and a mandible framework 224. The first tissue block 204 may be fabricated using a layering technique that includes, as a non-limiting example, three layers of a silicone-material each formulated to provide a specific material property. A first outer layer of the first tissue block 204 can be fabricated from a silicone material with a hardness between about OO-10 and OO-30 providing material properties that resemble human skin. The first outer layer of the first tissue block 204 can be a blend of Ecoflex® 30 of the Smooth-On Corporation, Slacker® of the Smooth-On Corporation, silicone oil and naphtha. A second layer within the first tissue block 204 can be fabricated from a silicone material with a hardness between about OOO-35 and OOO-80 providing material properties that resemble deep soft tissue layers in a human neck. The second layer within the first tissue block 204 can be a blend of Ecoflex® 10 of the Smooth-On Corporation, Slacker® of the Smooth-On Corporation, and silicone oil. A third layer within the first tissue block 204 and between the first outer layer and the second layer can be fabricated from a silicone material with a hardness between about OOO-15 and OOO-40 providing material properties that resemble fatty tissue within a human neck. The third layer within the first tissue block 204 and between the first outer layer and the second layer can be a blend of Ecoflex® 10 of the Smooth-On Corporation, Slacker® of the Smooth-On Corporation, Thi-Vex® of the Smooth-On Corporation, and Plat-Cat® of the Smooth-On Corporation. In this non-limiting example, each silicone-based layer used to fabricate the first tissue block 204 is a dielectric material that is designed to prevent shorting, when grounded as shown in FIG. 2, while a needle is inserted into the first tissue block 204.

In the illustrated, non-limiting example, the first tissue block 204 includes a right aperture 228, a central aperture 232, a left aperture 236, a front indentation 240, and a front surface 244. The right aperture 228 and the left aperture 236 are configured to receive the right muscle element 212 and the left muscle element 216, respectively. The central aperture 232 extends between a first opening 248 in the first tissue block 204 to a second opening 252 in the first tissue block 204 to form a lumen 256 extending through the first tissue block 204. The lumen 256 is in the form of an airway lumen within a human neck. The central aperture 232 is configured to receive the second tissue block 208 and the laryngeal framework 220. The front indentation 240 is configured to receive the mandible framework 224.

The front surface 244 of the first tissue block 204 defines an elongated external surface dimensioned to approximate a human neck. In the illustrated configuration, the front surface 244 is dimensioned to approximate an adult human neck with a non-limiting example circumference of about 14 inches measured at the thyroid cartilage. In other configurations, the front surface may be dimensioned to approximate an adult human neck with a circumference between about 12 inches and 17 inches measured at the thyroid cartilage. In other configurations, the front surface 244 can be dimensioned to approximate a child human neck with a circumference between about 6 inches and 10 inches in circumference measured at the thyroid cartilage.

In the illustrated, non-limiting example, the second tissue block 208 may be fabricated from a silicone material with a hardness between about OO-10 and OO-20 providing material properties that resemble soft tissue in a human larynx. The silicone based material used to fabricate the second tissue block 208 can be a blend of Ecoflex® 20 of the Smooth-On Corporation, silicone oil and naphtha. In this illustrated example, the silicone-based material used to fabricate the second tissue block 208 may be a dielectric material that is designed to prevent shorting, when grounded as shown in FIG. 2, while the needle is inserted into the second tissue block 208.

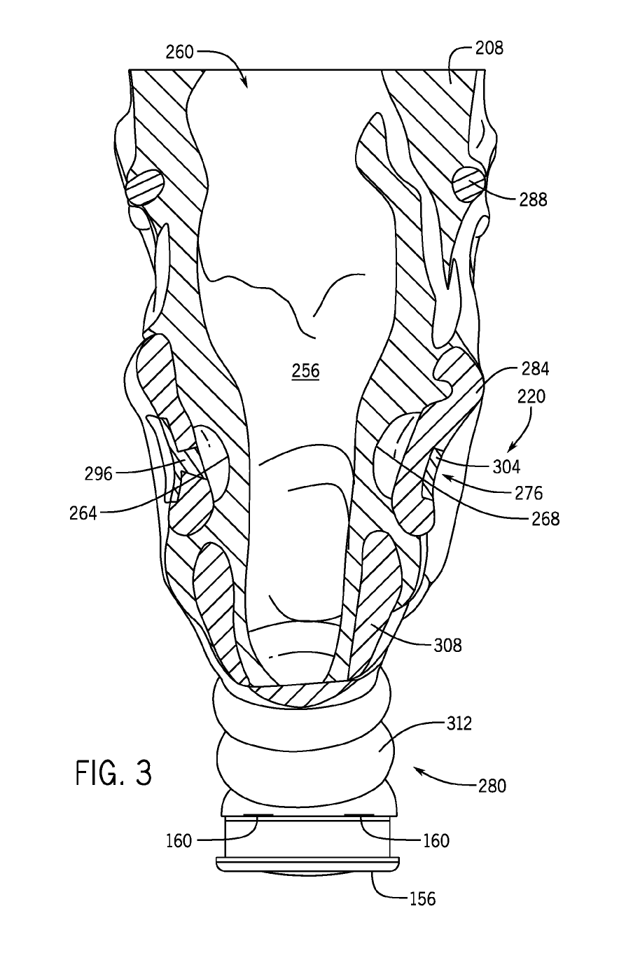

The second tissue block 208 is in the form of laryngeal soft tissue present within a human neck and includes a second central aperture 260, a right indentation 264, a left indentation 268, and a rear indentation 272. The second central aperture 260 extends along the lumen 256 from the first opening 248 of the first tissue block 204 to a position between the first opening 248 and the second opening 252. The right indentation 264 and the left indentation 268 are dimensioned and positioned to approximate the size and location of thyroarytenoid muscles of a human larynx. The rear indentation 272 is dimensioned and positioned to approximate the size and location of a posterior cricoarytenoid muscle modules of a human larynx. As shown in FIG. 2 and FIG. 3, the electrical connector 160 is configured to communicate with the right indentation 264, the left indentation 268 and the rear indentation 272, for example, via a wired electrical conductor.

The right muscle element 212 and the left muscle element 216 can be fabricated from a silicone material with a hardness between about 5 A and 30 A providing material properties that resemble muscles in a human neck. The silicone material used to fabricate the right muscle element 212 and the left muscle element 216 may be Dragon Skin® 10 of the Smooth-On Corporation. The right muscle element 212 and the left muscle element 216 are in the form of sternocleidomastoid muscles present within a human neck.

In the illustrated non-limiting example, the laryngeal framework 220 may include a first laryngeal framework 276 and a second laryngeal framework 280. The laryngeal framework 220 can be fabricated from a plastic material with a hardness between about 15 D and 130 R providing material properties that resemble cartilage in a human larynx. The plastic material used to fabricate the first laryngeal framework 276 may be FullCure® of Stratasys, Ltd, and/or ABSPlus-P430® of Stratasys, Ltd. The first laryngeal framework 276 includes a thyroid section 284 in the form of thyroid cartilage in a human larynx and a hyoid section 288 in the form of a hyoid bone in a human larynx attached to the thyroid section 284. The thyroid section 284 includes a right fill port 292 configured to receive a right port plug 296 and a left fill port 300 configured to receive a left fill port 304. The second laryngeal framework 280 includes a cricoid section 308 in the form of cricoid cartilage in a human larynx and a trachea section 312 in the form of upper tracheal rings in a human larynx.

In the illustrated, non-limiting example, the mandible framework 224 is fabricated from a plastic material with a hardness between about 30 D and 130 R providing material properties that resemble jaw bone in a human. The plastic material used to fabricate the mandible framework 224 may be ABSPlus-P430® of Stratasys, Ltd. The mandible framework 224 is in the form of a portion of a mandible bone, or chin, in a human jaw.

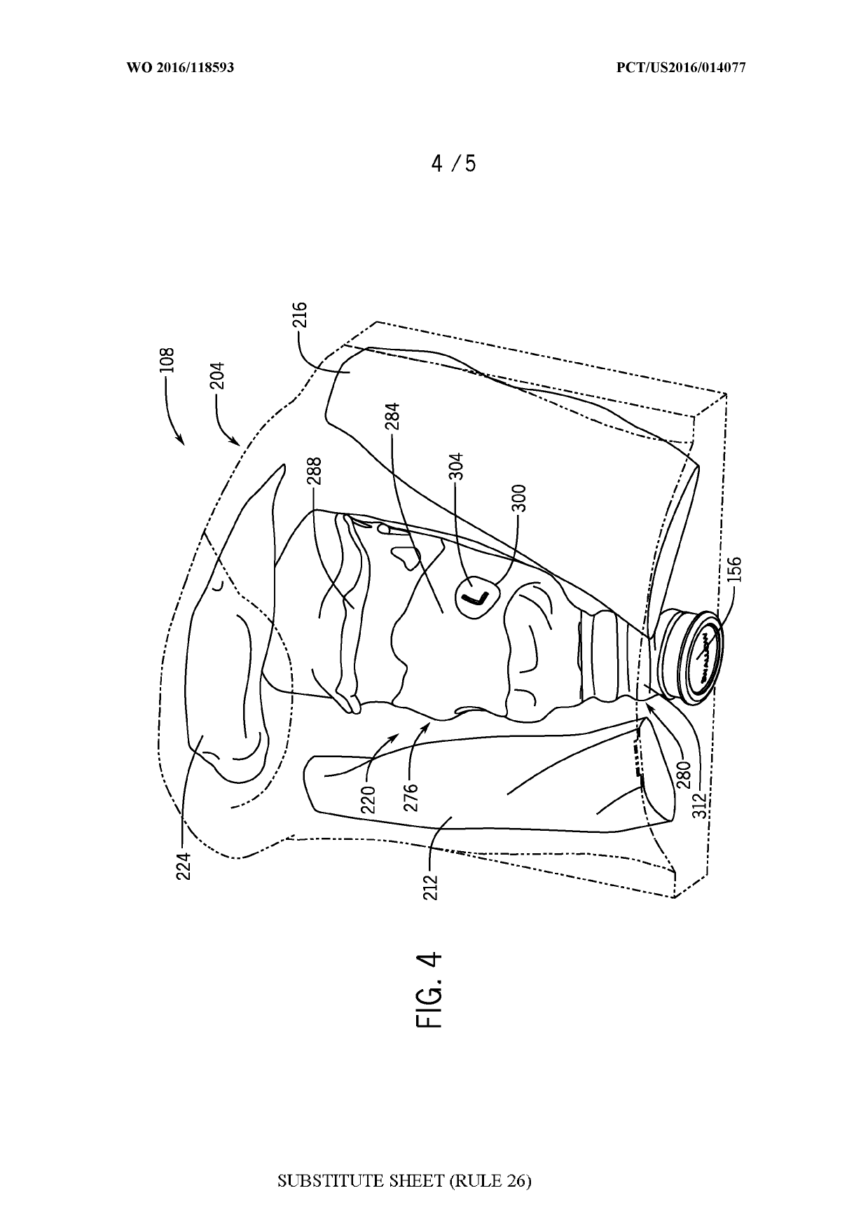

Assembly of the medical simulation apparatus 100 will be described with reference to FIGS. 1-4. The order in which the assembly of the medical simulation apparatus 100 is described is not meant to be limiting and it is to be understood that assembly of the medical simulation apparatus 100 is possible in different orders. The neck assembly 108 can be assembled by installing the right muscle element 212 into the right aperture 228 of the first tissue block 204 such that the right muscle element 212 does not protrude from the right aperture 228. With the right muscle element 212 arranged within the right aperture 228, the right muscle 212 provides a right palpable feature on the front surface 244 of the first tissue block 204. The left muscle element 216 is then installed into the left aperture 236 of the first tissue block 204 such that the left muscle 216 does not protrude from the left aperture 236. With the left muscle element 216 arranged within the left aperture 236, the left muscle 216 element provides a left palpable feature on the front surface 244 of the first tissue block 204. The mandible framework 224 is then installed into the front indentation 240 such that the mandible framework 224 does not protrude from the front indentation 240. With the mandible framework 224 arranged within the front indentation 240, the mandible framework 224 provides a upper palpable feature on the front surface 244 of the first tissue block 204.

The second tissue block 208 and the laryngeal framework 220 are then installed into the central aperture 232 by arranging the second laryngeal framework 280 within the central aperture 232 such that the trachea section 312 is flush with the second opening 252 and does not protrude from the second opening 252. The first laryngeal framework 276 is then installed onto the second tissue block 208 such that the right fill port 292 is centered over the right indentation 264 and the left fill port 300 is centered over the left indentation 268. The right indentation 264 is then filled with a conductive liquid through the right fill port 292 and the left indentation 268 is filled with the conductive liquid through the left fill port 300. The right port plug 296 is then installed into the right fill port 292 providing a sealing engagement and enclosing the right indentation 264. The left port plug 304 is then installed into the left fill port 300 providing a sealing engagement and enclosing the left indentation 268. The rear indentation 272 can be filled with the conductive fluid by injection. The conductive fluid may be ultrasound gel or, in other configurations, the conductive liquid may be any viable conductive liquid known in the art.

Once the first laryngeal framework 276 is installed onto the second tissue block 208, the second tissue block 208 is then inserted into the central aperture 232 such that the second tissue block 208 engages the cricoid section 308 of the second laryngeal framework 280. With the second tissue block 208 and the laryngeal framework 220 arranged within the central aperture 232, the laryngeal framework 220 provides an central palpable feature on the front surface 244 of the first tissue block 204.

With the neck assembly 108 assembled, the neck assembly 108 is then mounted in the base 104 by first installing the neck assembly 108 in the base 104 such that the display 148 is configured to view into the second central aperture 260 of the second tissue block 208 and the trachea section 312 of the second laryngeal framework 280 is concentric with the button aperture 152. The push button 156 is then installed into the button aperture 152 placing the push button into engagement with the second laryngeal framework 280. The fastening elements 132 are then installed into the first tissue block 204 through the mounting apertures 128 thereby fastening the neck assembly 108 to the base 104.

With the medical simulation apparatus 100 properly assembled, the electrical connector 160 is in communication with the right indentation 264, the left indentation 268, and the rear indentation 272. However, improper assembly of the medical simulation apparatus 100 can cause the right indentation 264, the left indentation 268, and/or the rear indentation 272 to not be in communication with the electrical connector 160. The processor 164 is configured to detect if the right indentation 264, the left indentation 268, and/or the rear indentation 272 are not in communication with the electrical connector 160 and instruct the display 148 to display an error message.

Though described above with respect to a non-limiting example of a neck simulator, the above-described concepts and techniques may be used to create a variety of other simulators. For example, as described above, particular materials or various materials having specific properties may be used to create a medical training simulator that realistically simulates various constituent materials of a patient, such as skin, soft tissue, cartridge, bone, and the like. Table I provided below presents a variety of non-limiting examples of properties and Table II provided below presents a variety of materials that may be used to create a simulator having realistic functional properties and/or anatomical arrangements.

The table below illustrates the mechanical properties of the various materials and the anatomical substance that, as a non-limiting example, may be used when fabricating the medical simulation apparatus 100.

TABLE I

| Simulated Substance | Hardness | Material Used |
|---|---|---|
| Skin Layer | ◯◯-10-◯◯-30A | eco-flex 30, slacker, |
| | | silicone oil, naphtha |
| Fat Layer | ◯◯◯-15-◯◯◯-40 | excoflex 10, slacker, |
| | | thi-vex II, plat-cat |
| Deep Neck Tissue Layer | ◯◯◯-35-◯◯◯-80 | excoflex 10, |
| (silicone) | | slacker, silicone oil |
| Sternocleidomastoid | 5A-30A | dragon skin 10 |
| Muscles | | |
| Laryngeal soft tissue | ◯◯-10-◯◯-20 | eco-flex 20, silicone |
| | | oil, naphtha |
| Thyroid cartilage | 15D-130R | FullCure 720 |
| Cricoid cartilage and | 15D-130R | ABSplus-P430 |
| upper tracheal rings | | |
| Mandible | 30D-130R | ABSplus-P430 |

Exemplary advantages of the above-described medical simulation apparatus 100 or other medical simulation devices designed or created using the above-described techniques or properties, will be discussed below with reference to operation of the medical simulation apparatus 100 by a user and/or an instructor. By no means is the following an exhaustive list of the numerous advantages provided by the invention, as will be understood by one of skill in the art.

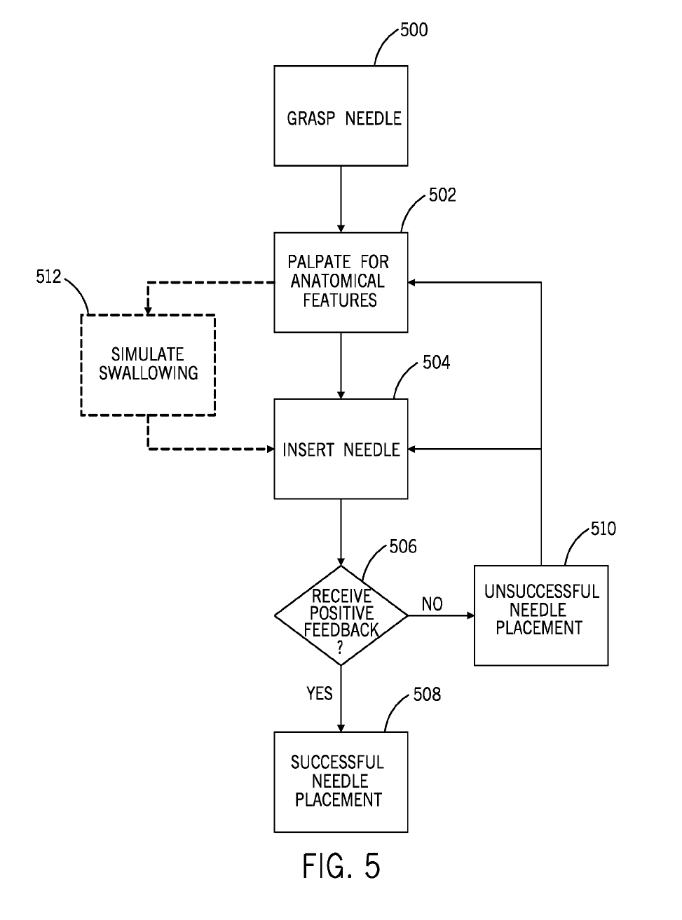

In operation, a user of the medical simulation apparatus 100 attempts to inject the needle 192 through the first tissue block 204 and contact the right indentation 264, the left indentation 268 or the rear indentation 272 in the second tissue block 208. FIG. 5 illustrates one non-limiting example of the step a user may take while operating the medical simulation apparatus 100. It should be known that the order of the steps illustrated in FIG. 5 are not meant to be limiting in any way. As shown in FIG. 5, a user can grasp the needle 192 at step 500. Once the user has grasped the needle 192, the user can palpate for anatomical features at step 502. For example, the user can be assisted in locating the right indentation 264, the left indentation 268, or the rear indentation 272 by palpating the right, left, upper, and/or central palpable features on the front surface 244 of the first tissue block 204. The right, left, upper, and central palpable features allow the user to gain a better understanding of where to insert the needle 192 in the first tissue block 204. Furthermore, the central palpable feature provided by the laryngeal framework 220 enables a user to grasp the laryngeal framework 220 through the first tissue block 204 and rotate the laryngeal framework 220. Rotation of the laryngeal framework 220 simultaneously rotates the second tissue block 208 within the central aperture 232 of the first tissue block 204, and enables the user to contact the rear indentation 272 with the needle 192. The rotation of the laryngeal framework 220 is enabled, in part, by viscoelastic properties provided by the layering of the different silicone formulations used to fabricate the first tissue block 204.

Following the user palpating for anatomical features at step 502, the user can insert the needle 192 into the second tissue block 208 at step 504 and attempt to contact the right indentation 264, the left indentation 268, or the rear indentation 272 with the needle 192. The processor 164 is configured to determine if the needle 192 has contacted the right indentation 264, the left indentation 268, or the rear indentation 272 at step 506. If the processor 164 determines that the needle 192 has contacted the right indentation 264, the left indentation 268, or the rear indentation 272, the processor 164 is configured to instruct the speaker 180 to play an audible sound providing the user with real-time feedback indicating that the needle 192 is properly inserted into the second tissue block 208. The audible sound may resemble electromyographic activity typically monitored during laryngeal injections to determine if the needle 192 has been properly inserted into the laryngeal musculature. Thus, if the user receives audible feedback, then they have properly inserted the needle 192 into the right indentation 264, the left indentation 268, or the rear indentation 272 at step 508. If no audible sound is provided to the user, then the user has not properly inserted the needle 192 into the right indentation 264, the left indentation 268, or the rear indentation 272 at step 510, and the user can return to palpating for anatomical features at step 502 and/or re-insert the needle 192 at step 504.

During operation of the medical simulation apparatus 100, the camera of the display 148 can be used to record images and/or video through the second central aperture 260 of the user attempting to contact the needle 192 with the right indentation 264, the left indentation 268, or the rear indentation 272. This can provide visual feedback for the user and progress of the user can be tracked over time by storing the images and/or video in the memory storage device 176. Additionally, an instructor teaching the user can watch the display 148 and provide instantaneous instructions.

Additionally, the viscoelastic properties provided by the layering of the different silicone formulations used to fabricate the first tissue block 204 enables the laryngeal framework 220 and the second tissue block 208 to displace in a longitudinal direction in response to a user, or an instructor, pressing on the push button 156. When a user, or an instructor, press on the push button 156 at step 512, the displacement of the laryngeal framework 220 and the second tissue block 208 simulate swallowing which can, and often does, occur during injections into the laryngeal musculature. Swallowing can cause the needle 192 to displace while inserted into the first tissue block 204 and the user can learn to anticipate and/or adapt to swallowing reducing discomfort and/or chance of injury to a human patient. In other configurations, the push button 156 may include an electronic actuator, as described above, and the processor 164 may be configured to randomly instruct the electronic actuator to displace the push button 156 in a longitudinal direction without the user, or instructor, manually pressing the push button 156.

It is to be understood that the invention is not limited in its application to the details of construction and the arrangement of components set forth in the preceding description or illustrated in the drawings. The invention is capable of other configurations and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The above discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The preceding detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Thus, while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

1. A medical simulation apparatus comprising:
a first tissue block fabricated from one or more layers each providing substantially different material properties configured to resemble at least one of human skin, fatty tissue within a human neck, and deep soft tissue layers within a human neck;
a second tissue block configured to resemble laryngeal soft tissue within a human neck;
one or more muscle elements configured to resemble sternocleidomastoid muscles within a human neck;
one or more frameworks configured to resemble at least one of a larynx and a mandible in a human neck; and
a processor in communication with a feedback device, wherein the processor is configured to cause at least one of auditory and visual feedback to be provided to a user through the feedback device during a training procedure performed on the medical simulation apparatus.

2. The medical simulation apparatus of claim 1, wherein the one or more layers of the first tissue block includes a first outer layer configured to resemble human skin, a second layer within the first tissue block configured to resemble fatty tissue within a human neck, and a third layer within the first tissue block between the first outer layer and the second layer resemble deep soft tissue layers within a human neck.

3-5. (canceled)

6. The medical simulation apparatus of claim 1, wherein the second tissue material is a silicone based material.

7. The medical simulation apparatus of claim 1, wherein the muscle material is a silicone based material.

8. The medical simulation apparatus of claim 1, wherein the framework material is a plastic material.

9. The medical simulation apparatus of claim 1, wherein the second tissue block is arranged within a first aperture of the first tissue block and includes one or more indentations configured to resemble at least one of thyroarytenoid and cricoarytenoid muscles within a human neck.

10-29. (canceled)

30. A medical simulation apparatus configured to simulate a human neck, the medical simulation apparatus comprising:
a first tissue block including a first surface, a right aperture, a left aperture, and a central aperture, the first surface defining an elongated external surface dimensioned to approximate a human neck;
a right muscle element arranged within the right aperture and providing a right palpable feature on the first surface;
a left muscle element arranged within the left aperture and providing a left palpable feature on the first surface; and
a framework arranged within the central aperture and providing a central palpable feature on the first surface.

31. The medical simulation apparatus of claim 30, wherein the framework is rotatable within the first tissue block.

32. The medical simulation apparatus of claim 31 further comprising a second tissue block arranged within the central aperture and including a right indentation, a left indentation, and a rear indentation.

33-34. (canceled)

35. The medical simulation apparatus of claim 32, wherein the first tissue block is mounted in a base.

36. The medical simulation apparatus of claim 35, wherein the base includes a button aperture configured to receive a push button, the push button configured to displace the framework and the second tissue block in a longitudinal direction in response to a user pressing the push button.

37. The medical simulation apparatus of claim 30, wherein the first tissue block is fabricated a first outer layer, a second layer within the first tissue block, and a third layer within the first tissue block between the first outer layer and the second layer.

38. The medical simulation apparatus of claim 30, wherein the first outer layer is fabricated from a silicone material with a hardness between about OO-10 and OO-30.

39. The medical simulation apparatus of claim 30, wherein the second layer is fabricated from a silicone material with a hardness between about OOO-35 and OOO-80.

40. The medical simulation apparatus of claim 30, wherein the third layer is fabricated from a silicone material with a hardness between about OOO-15 and OOO-40.

41. The medical simulation apparatus of claim 32, wherein the second tissue block is fabricated from a silicone material with a hardness between about OO-10 and OO-20.

42. The medical simulation apparatus of claim 30, wherein the framework is fabricated from a plastic material with a hardness between about 15 D and 130 R.

43-44. (canceled)

45. The medical simulation apparatus of claim 30, wherein the right and left muscle elements are fabricated from a silicone material with a hardness between about 5 A and 30 A.

46. The medical simulation apparatus of claim 1, wherein one or more frameworks comprise a laryngeal framework that is configured to be rotatable within the first tissue block.

47. The medical simulation apparatus of claim 9, wherein the first aperture extends between a first opening and a second opening in the first tissue block to form a lumen, wherein the lumen is configured to resemble an airway lumen within a human neck.
